(19) United States
(12) Patent Application Publication
(10) Pub. No.: US 2011/0265310 A1
(43) Pub. Date: Nov. 3, 2011

(54) Fastening device template

(76) Inventor: CHARLES BEAULIEU, ST-JUST-DE-BRETENIERE (CA)

(21) Appl. No.: 13/042,594

(22) Filed: Mar. 8, 2011

Related U.S. Application Data
(63) Continuation-in-part of application No. 12/411,256, filed on Mar. 25, 2009, now abandoned.

(51) Int. Cl. B23P 11/00; F16B 2/22

(52) U.S. Cl. 29/525.08; 24/545

(57) ABSTRACT

A fastening device template for joining mosaic pieces together having two variants that are easy to install by unskilled labor so as to help them achieve professional result. The device can be for assembling individual planks that together make up a floor covering such as solid wood flooring and engineered flooring, or it can be used for tiles. It can also be used to assemble individual parts which, together, create a piece of furniture. In this application, the generic term “mosaic” or “mosaic units” will be used to describe the individual pieces which, as indicated hereinabove, have a multitude of possible uses. Mosaic units can be assembled in all possible XYZ plans: side-to-side, side-to-face, side-to-end, end-to-end, end-to-face. In order to do so, the invention has an elongated clip core. At least one wing member attached to and extending a portion of the length of the clip core, and resilient leg members adapted to be frictionally inserted within a groove of a mosaic piece.

This application is a CIP of application Ser. No. 12/411,256 filed Mar. 25, 2009

### FIELD OF THE INVENTION

The present invention relates generally to fastening means but more particularly to a fastening device template used in joining mosaics.

### BACKGROUND OF THE INVENTION

There are many types of fastening means used for assembling parts together such as for building furniture or joining pieces of lumber or planks such as for flooring for example. These fastening means come in the forms of mortise and tenon; tongue and groove; dovetail; dowel; biscuit; etc.

A fastening means of particular relevance is that of U.S. Pat. No. 7,021,019 by Knauseder. However, that patent bears some striking differences as it is used for a different use.

| Beaulieu | Knauseder |
|---|---|
| Longitudinal profile of the clip | Horizontally flat configuration of |
| | the clip |
| Protruding tips | Tapered arms |
| Clipped in a groove or channel | Clipped in a recess |
| Clip and groove profile need to fit | Clip and recess do not need to be |
| perfectly | manufactured with great accuracy |
| Clip that can slide along the groove | Clip that cannot slide within the |
| | recess |
| Clip inserted in a plan perpendicular | Clip inserted is only feasable in a |
| to the surface of the board (side) | plan parallel to the surface of the |
| for flooring applications, and on every | panel (underside) |
| other possible plan of mosaic pieces | |
| for applications such as cabinet box | |
| construction. | |
| Groove & groove profile (no tongue) | Panels still require a tongue & a |
| | groove |

### SUMMARY OF THE INVENTION

It is a main advantage of this invention to provide for a fastening device template that is easy to install by unskilled labor so as to help them achieve professional result. The application can be for assembling individual planks that together make up a floor covering such as solid wood flooring and engineered flooring, or it can be used for tiles. It can also be used to assemble individual parts which, together, create a piece of furniture. In this application, the generic term “mosaic” or “mosaic units” will be used to describe the individual pieces which, as indicated hereinabove, have a multitude of possible uses. Mosaic units can be assembled in all possible XYZ plans: side-to-side, side-to-face, side-to-end, end-to-end, end-to-face, face-to-face.

In order to do so, the invention comprises two variants of a fastening device template for binding a plurality of mosaic units. The first variant of the fastening device has an elongated clip core. At least one wing member attached to and extending a portion of the length of the clip core, the at least one wing member consisting of two resilient leg members adapted to flex and be frictionally inserted within a groove of a mosaic piece; and a fastening member attached to an opposite side of the clip core from the at least one wing member that is adapted to attach to a chosen support member, to thereby frictionally hold the mosaic piece to a chosen support member.

The fastening device typically comprises two wing members.

The fastening device has each leg member having a protruding tip at a distal end thereof, such that the protruding tips extend in opposite directions from one another; and wherein each leg member and protruding tip is adapted to fit within a complementary configured and sized opening of the mosaic pieces.

The second variant comprises an elongated clip core, at least one wing member attached to and extending a portion of the length of the clip core, the at least one wing member consisting of one resilient leg members adapted to be frictionally inserted within a groove of a mosaic piece; and a fastening member attached to an opposite side of the clip core from the at least one wing member that is adapted to attach to a chosen support member, to thereby frictionally hold the mosaic piece to a chosen support member.

The clip core of the second variant further includes a resilient central large protruding tip adapted to further increase the friction between the fastening device and the mosaic piece.

Both variants can be made from a material chosen from a list of materials including plastic, metal, ferrous material, and wood.

A method of joining mosaic pieces comprises the steps of:

a.) providing at least two mosaic pieces having predetermined sized and shaped grooves on their sides, ends or faces and extending along their lengths;
b.) providing a fastening device between each adjoining pair of mosaic pieces, and inserting the fastening device within the respective grooves to thereby frictionally hold the mosaic pieces together; wherein the fastening devices each comprise two wing members attached at and extending from opposite sides of the clip core and extending a portion of the length of the clip core, the two wing members each consisting of resilient leg members adapted to be frictionally inserted within the grooves of the adjacent mosaic pieces, and wherein each leg member has a protruding tip at a distal end thereof, such that the protruding tips extend in opposite directions from one another; and wherein each leg member and protruding tip is adapted to complementarily fit within the configured and sized opening of respective the adjacent mosaic pieces.

The method of joining mosaic pieces, wherein step a.) further includes placing glue within the grooves of the mosaic pieces before placing the fastening devices therein, to thereby further strengthen the final connection between respective mosaic pieces.

The method of joining mosaic pieces, wherein the fastening device can be made from a material chosen from a list of materials including plastic, metal, ferrous material, and wood.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. Such as the previously listed side-to-side, side-to-face, side-to-end, end-to-end, end-to-face, face-to-face configurations. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of a first variant of the invention showing insertion through the side of a mosaic.

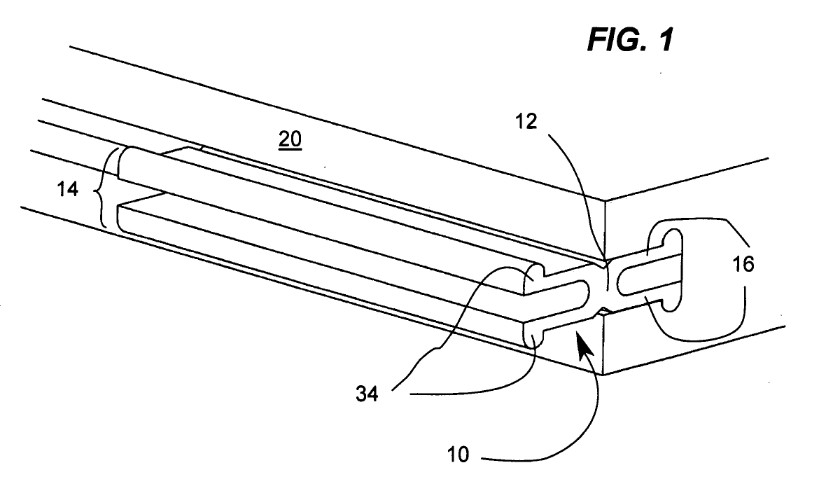

FIG. 2 Isometric view of a second variant of the invention showing insertion through the side of a mosaic.

FIGS. 3a-b End view, and end view detail, respectively, of the invention of FIG. 1 in context of use in a side by side mosaic configuration.

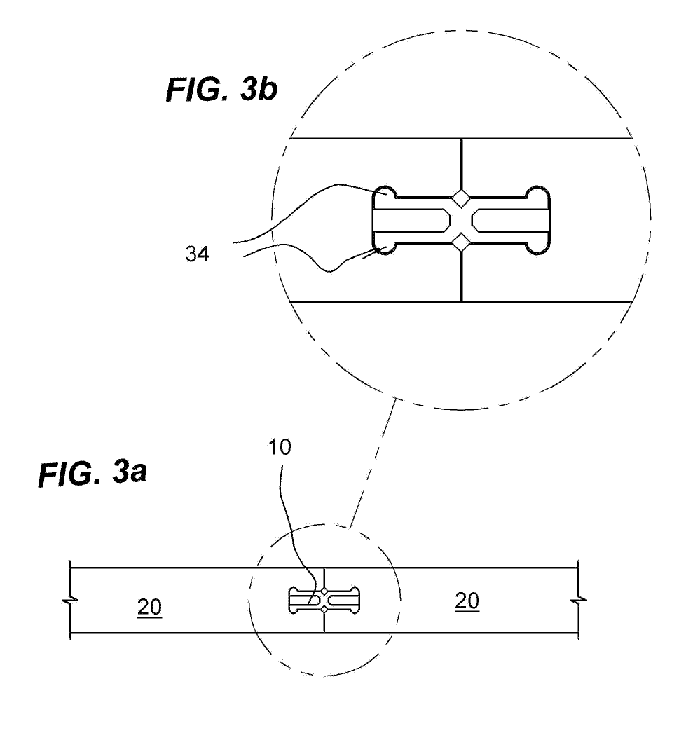

FIGS. 4a-b End view, and end view detail, respectively, of the invention of FIG. 2 in context of use in a side by side mosaic configuration.

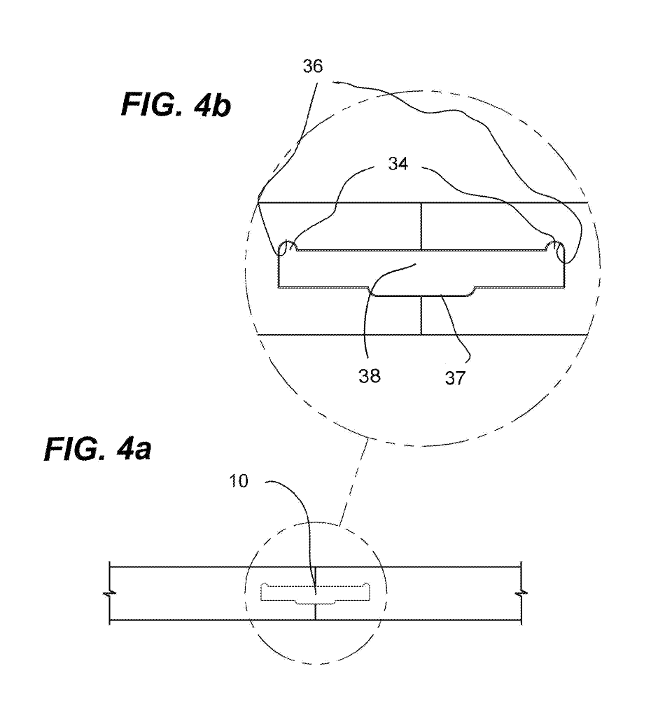

### DETAILED DESCRIPTION

A fastening device (10) has a clip core (12) and wings (14). The wing (14) generally consists in twin legs (16) that are resiliently flexible to allow for frictional insertion into a groove (18) made into a plank, board, piece of furniture henceforth referred to as a mosaic (20).

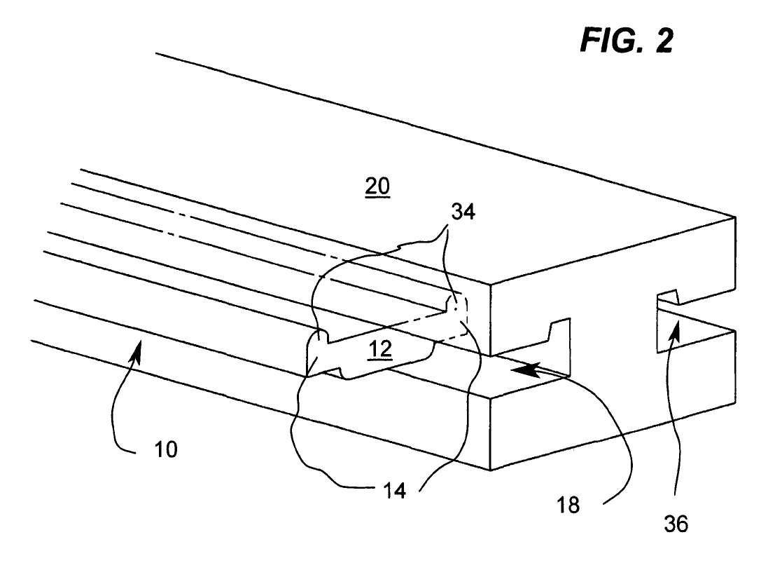

A second type of the fastening device (10), as seen in FIG. 2, has a clip core (12) and wings (14). Each wing (14) is ended by a protruding tip (34) and is configured and sized for frictional insertion into complementarily configured and sized openings (36). A central large protruding tip (37) at the clip core (38) is frictionally interacting a part of the mosaic (20). The use of resilient deformation for insertion of one element into another element wherein both elements present complementarily configured and sized shapes is known in the art and need not be further discussed herein.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A fastening device for joining mosaic pieces together comprising an elongated clip core; at least one wing member attached to and extending a portion of the length of said clip core, said at least one wing member consisting of two resilient leg members adapted to flex and be frictionally inserted within a groove of a mosaic piece; and a fastening member attached to an opposite side of said clip core from said at least one wing member that is adapted to attach to a chosen support member, to thereby frictionally hold said mosaic piece to a chosen support member.

2. The fastening device of claim 1, wherein said fastening device comprises two wing members.

3. The fastening device of claim 1, wherein each leg member has a protruding tip at a distal end thereof, such that said protruding tips extend in opposite directions from one another; and wherein each leg member and protruding tip is adapted to fit within a complementary configured and sized opening of said mosaic pieces.

4. A fastening device for joining mosaic pieces together comprising an elongated clip core; at least one wing member attached to and extending a portion of the length of said clip core, said at least one wing member consisting of one resilient leg members adapted to be frictionally inserted within a groove of a mosaic piece; and a fastening member attached to an opposite side of said clip core from said at least one wing member that is adapted to attach to a chosen support member, to thereby frictionally hold said mosaic piece to a chosen support member.

5. The fastening device of claim 4, wherein said clip core further includes a resilient central large protruding tip adapted to further increase the friction between said fastening device and said mosaic piece.

6. The fastening device of claim 1, wherein said fastening device can be made from a material chosen from a list of materials including plastic, metal, ferrous material, and wood.

7. The fastening device of claim 4, wherein said fastening device can be made from a material chosen from a list of materials including plastic, metal, ferrous material, and wood.

8. A method of using the fastening device for joining mosaic pieces of claim 1, said method comprising the steps of:
a.) providing at least two mosaic pieces having predetermined sized and shaped grooves on their sides, ends or faces and extending along their lengths;
b.) providing a fastening device between each adjoining pair of mosaic pieces, and inserting said fastening device within said respective grooves to thereby frictionally hold said mosaic pieces together; wherein said fastening devices each comprise two wing members attached at and extending from opposite sides of said clip core and extending a portion of the length of said clip core, said two wing members each consisting of two resilient leg members adapted to flex and be frictionally inserted within said grooves of said adjacent mosaic pieces, and wherein each leg member has a protruding tip at a distal end thereof, such that said protruding tips extend in opposite directions from one another; and wherein each leg member and protruding tip is adapted to complementarily fit within said configured and sized opening of respective said adjacent mosaic pieces.

9. The method of joining mosaic pieces of claim 8, wherein step a.) further includes placing glue within said grooves of said mosaic pieces before placing said fastening devices therein, to thereby further strengthen the final connection between respective mosaic pieces.

10. The method of joining mosaic pieces of claim 8, wherein said fastening device can be made from a material chosen from a list of materials including plastic, metal, ferrous material, and wood.

11. A method of using the fastening device for joining mosaic pieces of claim 4, said method comprising the steps of:
a.) providing at least two mosaic pieces having predetermined sized and shaped grooves on their sides, ends or faces and extending along their lengths;
b.) providing a fastening device between each adjoining pair of mosaic pieces, and inserting said fastening device within said respective grooves to thereby frictionally hold said mosaic pieces together; wherein said fastening devices each comprise two wing members attached at and extending from opposite sides of said clip core and extending a portion of the length of said clip core, said two wing members each consisting of a leg member adapted to be frictionally inserted within said grooves of said adjacent mosaic pieces, and wherein each leg member has a protruding tip at a distal end thereof, such that said protruding tips extend in opposite directions from one another; and wherein each leg member and protruding tip is adapted to complementarily fit within said configured and sized opening of respective said adjacent mosaic pieces.

12. The method of joining mosaic pieces of claim 11, wherein said clip core further includes a resilient central large protruding tip adapted to further increase the friction between said fastening device and said mosaic piece.

13. The method of joining mosaic pieces of claim 11, wherein step a.) further includes placing glue within said grooves of said mosaic pieces before placing said fastening devices therein, to thereby further strengthen the final connection between respective mosaic pieces.

14. The method of joining mosaic pieces of claim 11, wherein said fastening device can be made from a material chosen from a list of materials including plastic, metal, ferrous material, and wood.
